(19) United States
(12) Patent Application Publication
(10) Pub. No.: US 2024/0273520 A1
(43) Pub. Date: Aug. 15, 2024

(54) SYSTEMS AND METHODS FOR USING AMMUNITION AS A MEDIUM OF EXCHANGE BETWEEN ONLINE PARTIES

(71) Applicant: Dan Morton, Nampa, ID (US)

(72) Inventor: Dan Morton, Nampa, ID (US)

(21) Appl. No.: 18/225,669

(22) Filed: Jul. 24, 2023

Related U.S. Application Data
(60) Provisional application No. 63/391,446, filed on Jul. 22, 2022.

(51) Int. Cl. G06Q 20/38

(52) U.S. Cl. CPC G06Q 20/38

(57) ABSTRACT

A system for using ammunition as a medium of exchange between online parties is disclosed, including at least one user computing device in operable connection with a user network. An application server is in operable communication with the user network to host an application program for using ammunition as a medium of exchange between online parties. A processor and a non-transitory, computer readable memory stores instructions that, when executed by the processor upon a user selection, cause the application program to search a plurality of databases for a plurality of ammunition prices and attribute each of the plurality of ammunition prices to a caliber. A sender selects an allocation percentage associate with a budget. The allocation percentage is associated with a generic SKU associated with an amount of each caliber of ammunition to transfer to a recipient. The allocation module converts the generic SKU to the specific SKU.

### CROSS-REFERENCE TO RELATED APPLICATIONS

The present application claims priority to U.S. Provisional Application No. 63/391,446 filed Jul. 22, 2022, titled “SYSTEM FOR USING AMMUNITION AS A MEDIUM OF EXCHANGE BETWEEN TWO PARTIES ONLINE” which is hereby incorporated by reference in its entirety.

### TECHNICAL FIELD

Embodiments of the invention relate to system for online exchanges of currency and more specifically to systems for using ammunition as a medium of exchange between two or more parties.

### BACKGROUND

Individuals have engaged in commerce throughout history using various methods of trading assets. In recent years, advances in technology have allowed for commerce to be conducted online via the Internet, wherein goods and services are bought and sold using payment processing systems. These payment processing systems communicate with the banks of the customer and provider of the good or services to securely execute a transaction. These systems have also incorporated inventory management systems to ensure the good being purchased is available at the time of purchase.

While it is most common for a standard currency (such as the US Dollar or similar currency) to be used in an online transaction, the use of fiat currencies is also known. However, systems do not exist which allow for ammunition to be used as a medium to execute a transaction.

### SUMMARY OF THE INVENTION

This summary is provided to introduce a variety of concepts in a simplified form that is disclosed further in the detailed description of the embodiments. This summary is not intended for determining or limiting the scope of the claimed subject matter.

The embodiments provided herein relate to systems for using ammunition as a medium of exchange between online parties is disclosed, including at least one user computing device in operable connection with a user network. An application server is in operable communication with the user network to host an application program for using ammunition as a medium of exchange between online parties. A processor and a non-transitory, computer readable memory stores instructions that, when executed by the processor upon a user selection, cause the application program to search a plurality of databases for a plurality of ammunition prices and attribute each of the plurality of ammunition prices to a caliber. A sender selects an allocation percentage associate with a budget. The allocation percentage is associated with a generic SKU associated with an amount of each caliber of ammunition to transfer to a recipient. The allocation module converts the generic SKU to the specific SKU.

The system allows a user (i.e., the customer) to purchase fractional rounds of ammunition rather than purchasing entire ammunition rounds or boxes of ammunition. The system includes a means of providing a percentage allocation of a budget across multiple generic SKUs which can be converted to specific SKUs at the time of shipment. The user may establish a shipping initiator as well as an automated shipment option to provide an automated means of receiving ammunition and user-specified intervals. The generic SKU will be converted to a specific SKU prior to shipment such that the customer receives a predetermined amount of various forms of ammunition.

The system provides the ability to transfer ammunition to other users electronically in either an ammunition round count or dollar equivalent associated with the ammunition round count and its pricing. In another aspect, the system provides the ability to request ammunition from other users electronically in either an ammunition round count or dollar amount equivalent associated with the ammunition round count and its pricing. This allows for the ammunition to be utilized as an exchange medium between two or more parties.

Once customers have determined the calibers, percentages, budget and billing cycle, they have the opportunity to set up a shipping trigger based on a number of different variables. The first variable may be the number of rounds in inventory they have accumulated. The second variable may be the dollar value of the inventory they have accumulated. The third variable may be the number of months that have elapsed since their last shipment. The fourth variable may be to store and hold in the warehouse indefinitely.

Other objects and advantages of the various embodiments of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRA WINGS

A more complete understanding of the embodiments, and the attendant advantages and features thereof, will be more readily understood by references to the following detailed description when considered in conjunction with the accompanying drawings wherein:

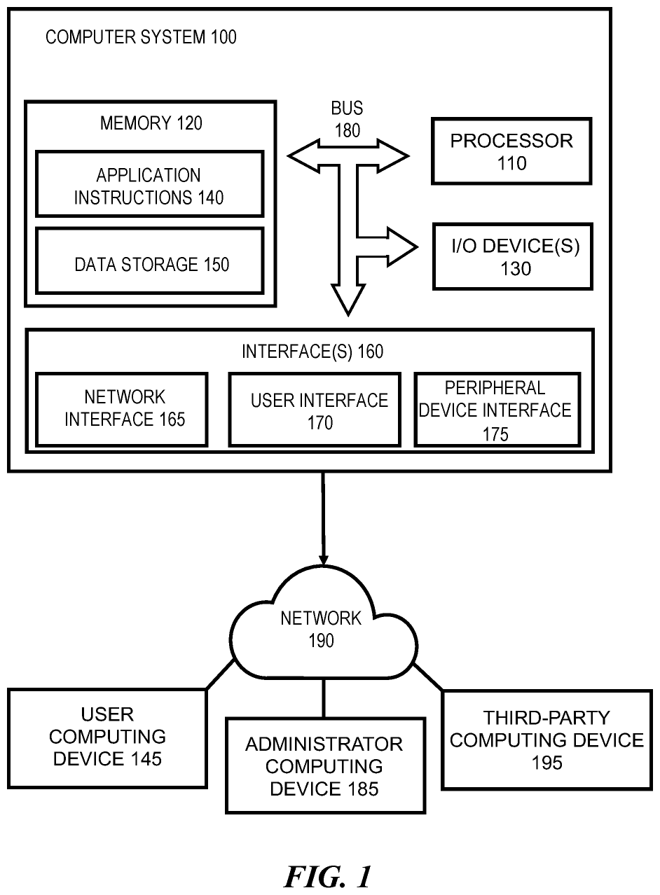

FIG. 1 illustrates a block diagram of the computer system, according to some embodiments;

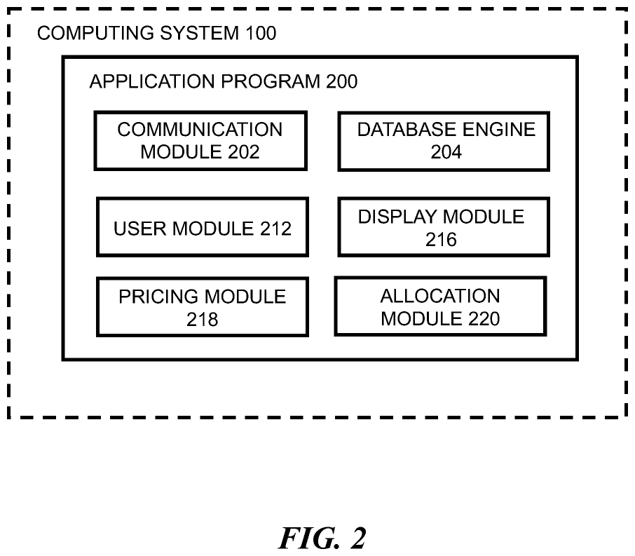

FIG. 2 illustrates a block diagram of the application program and computing system, according to some embodiments;

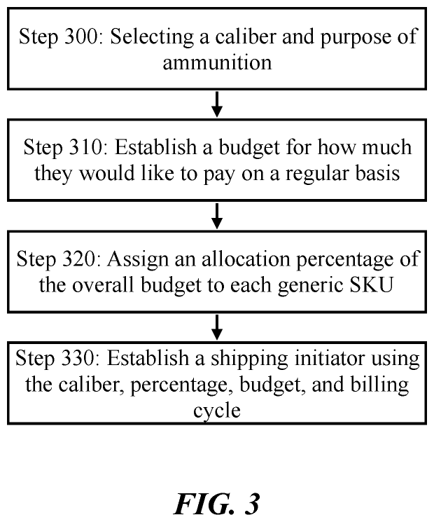

FIG. 3 illustrates a flowchart of the customer subscription process, according to some embodiments;

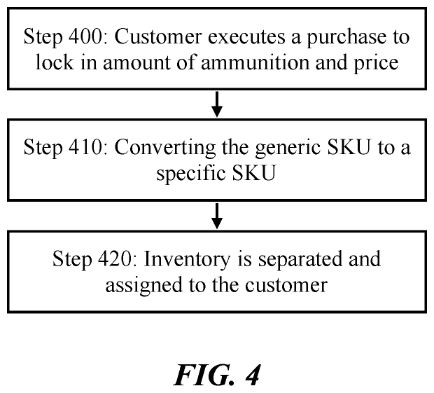

FIG. 4 illustrates a flowchart of the inventory allocation and warehousing process, according to some embodiments;

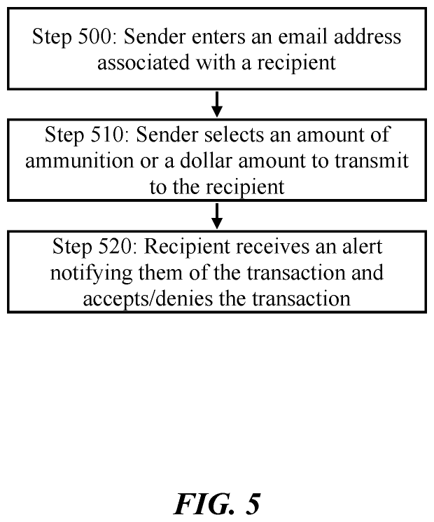

FIG. 5 illustrates a flowchart of the process for sending or requesting ammunition, according to some embodiments;

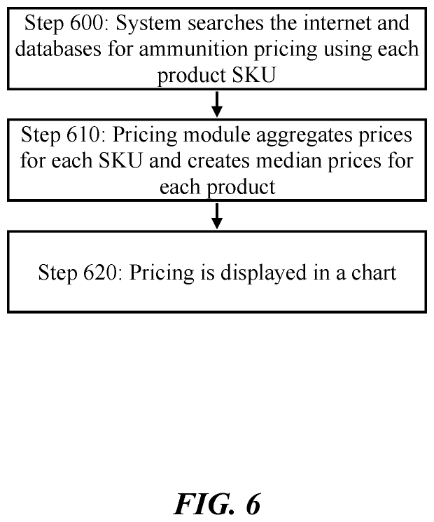

FIG. 6 illustrates a flowchart of the ammunition pricing and SKU management process, according to some embodiments; and

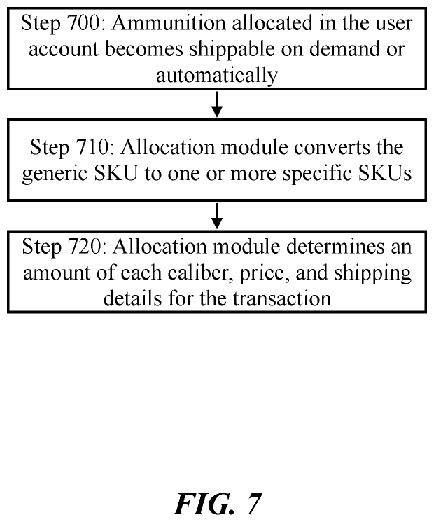

FIG. 7 illustrates a flowchart of the shipping and delivery process, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to systems for using ammunition as a medium of exchange between two or more online parties. The system allows a user (i.e., the customer) to purchase fractional rounds of ammunition rather than purchasing entire ammunition rounds or boxes of ammunition. The system includes a means of providing a percentage allocation of a budget across multiple generic SKUs which can be converted to specific SKUs at the time of shipment. The system includes various means of indicating a shipping trigger (such as when a price point for the ammunition is reached, ammunition amount is reached etc.) as well as an automated shipment option. The generic SKU will be converted to a specific SKU prior to shipment such that the customer receives a predetermined amount of various forms of ammunition.

The system provides the ability to transfer ammunition to other users electronically in either an ammunition round count or dollar equivalent associated with the ammunition round count and its pricing. Further, the system provides the ability to request ammunition from other users electronically in either an ammunition round count or dollar equivalent associated with the ammunition round count and its pricing.

In some embodiments, ammunition and gear purchases are stored offsite and delivered on-demand once purchasing and shipping parameters are met.

In some embodiments, ammunition is added to a “queue” before it is allocated to inventory. Ammunition in the queue may not be stored in physical form in the warehouse. Once it is allocated to inventory it is physically in the warehouse.

In some embodiments, ammunition is pooled together and not segregated physically for each customer. Ammunition may be purchased and/or sold via a limit price.

In some embodiments, the system utilizes a market pricing mechanism that automatically determines the current median market price of our Generic SKUs by aggregating prices from dozens of vendors for the specific UPCs that make up our Generic SKU.

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C #, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized a user (e.g., a healthcare provider) to interact with the various functionalities of the system including to perform patient rounds, handoff patient rounding responsibility, perform biometric verification tasks, and other associated tasks and functionalities of the system. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

FIG. 2 illustrates an example computer architecture for the application program 200 operated via the computer system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a user module 212, a display module 216, a pricing module 218, and an allocation module 220.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 302 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195.

In some embodiments, the communication module 202 allows for senders and receivers of the ammunition or dollar equivalent to communicate with one another, transmit details related the sending and receiving of ammunition or equivalent dollar amount, etc.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

In some embodiments, the database engine 204 is in operable communication with various ammunition databases to assess pricing of each ammunition caliber and assess inventory levels of each ammunition caliber which is sent to the pricing module 218 to provide a price to each user (i.e., the sender and/or recipient) of the system.

The user module 212 may store user preferences including caliber preferences, pricing preferences, and auto-ship preferences such that the system may autonomously execute purchasing processes as described herein.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. The display module 216 provides alerts to the user device which can be viewed and acknowledged by the user.

In some embodiments, the pricing module 218 receives a plurality of pricing data from various ammunition sources. The pricing module 218 may then determine a median price (or other price point) by analyzing the pricing data. The pricing module 218 is in operable communication with the allocation module 220 which allocates rounds of ammunition to each recipient.

### Customer Subscription Process

FIG. 3 illustrates a flowchart of the customer subscription process. In some embodiments, and in step 300, customers start the process by selecting a caliber and purpose of ammunition they are interested in. In step 310, once they have selected a caliber and the purpose of ammunition, they set a budget for how much they would like to pay on a regular basis. The customer may also pick the billing cycle they want (weekly, monthly, bi-monthly or quarterly) the auto-buy to happen. This auto-buy feature (i.e., subscription) offers more flexibility and unlimited customizations to our ammunition subscription services.

In some embodiments, and in step 320, customers may assign an allocation percentage of their overall budget to each generic SKU. The percentage of the budget determines how much of each SKU the customer receives. The system will maximize the number of ammunition rounds and purchase up to a tenth of a fraction of a round. For example, a budget of $100 can be allocated to two generic SKUs such as SKU A (first SKU) at 60% and SKU B (second SKU) at 40%. At the time of purchase the SKU A is priced at $0.50 and SKU B is priced at $0.42. The system may then allocate 120.0 rounds of SKU A and 95.2 rounds of SKU B to the customer.

Once customers have determined the calibers, percentages, budget and billing cycle, they have the opportunity to set up a shipping trigger based on a number of different variables, in step 330. The first variable may be the number of rounds in inventory they have accumulated. The second variable may be the dollar value of the inventory they have accumulated. The third variable may be the number of months that have elapsed since their last shipment. The fourth variable may be to store and hold in the warehouse indefinitely.

The customer may be notified when a shipping trigger has been met. A notification can be an email or SMS message. Each shipping trigger has an option to “auto-ship” which will automatically charge the customer for shipping and have the inventory shipped without any need for customer intervention.

Customers can purchase ammunition independently from the auto-buy mechanism above. They can select the caliber and purpose they want, enter the number of rounds and purchase those rounds “at the market” price or set their own price. The market price is the price the system stablishes daily based on the current median market price of all of the individual SKUs on multiple online retailers that make up a generic SKU price. The order to purchase ammo at a price lower than our market price is held in the system and checked hourly and doesn't execute until the order price meets the market price. Then, the customer's purchase is made and queued up for allocation.

Customers can also set their own ammunition sale price and put a price higher than the market price that they are willing to sell the ammunition at. This sale price will be held in the system until the market price rises and meets the order price in the system. The purchase is then executed, and the customers inventory is sold.

### Inventory Allocation and Warehousing

FIG. 4 illustrates a flowchart of the inventory allocation and warehousing process. In some embodiments, a customer's purchase locks in the amount of rounds and the price paid in step 400. This initial purchase goes into an online queue that will allow us to know how much ammunition to purchase. In some cases that ammunition is already pre-purchased and can be allocated to the customers inventory right away. In other cases, the customer will have their ammunition in queue until administrators of the system can purchase the ammo and bring it physically in our warehouse. As ammunition physically arrives at the warehouse and gets checked into the inventory management system the internal system will then allocate the ammunition to the customer's inventory.

In step 410, inventory is still listed on the customer account as a Generic SKU (i.e., 9 mm Self Defense) and does not convert into a specific SKU until shipping (see description below). Customers can return ammunition for account credit at any time.

In step 420, ammunition may be physically stored in large pallets and cases for our customers. It is broken out by customer in our software and aggregated so we know how much we should have on hand and how much of particular SKUs we need to place orders with manufacturers and distributors.

### Send or Request Ammunition

FIG. 5 illustrates a process for sending and requesting ammunition as shown in steps 500-520. Customers have the ability to send ammunition to anyone in the world using the electronic platform using just an email address associated with the recipient. The sender enters the person's email address and chooses the ammunition within the system they want to send. The ammunition can exist in their own inventory or doesn't have to be something they currently are holding in their inventory. The sender will then determine how many rounds, or the dollar amount they want to send, and they can add a message. The sender can even enter partial rounds. If the customer has the ammunition, they can choose to use this or if they do not add a payment method to pay for the ammunition they are sending. The customer can also use a partial amount of their own ammunition and partially pay for the difference with their payment method on file.

The receiver will then get a notification (via email or text) related to the ammunition that has been sent to them. Once the person accepts that ammunition (clicking on a link in the notification or for existing customers on their account dashboard) the system will add the ammunition to their inventory if inventory was sent or in the queue depending on whether the ammunition was originally in the sender's inventory or not when sent. If the customer receiving the ammunition exists and has a crate they will be asked where they want the ammunition to be stored. The ammunition transaction can be canceled by the sender at any point before the ammunition has been claimed by the receiver.

A user can also use the system to request ammunition from anyone. To accomplish this, they enter the senders email address and then follow similar steps as above of determining which ammunition from our system they would like and entering the number of rounds or the dollar value equivalent. The customer can request partial rounds if desired. The person getting the request can choose to provide the ammunition from their inventory or pay for the ammunition if they do not have it or they can ignore the request and do nothing. The request will self-expire after a certain amount of time, or it can be canceled by either party.

### Ammunition Pricing and SKU Management

FIG. 6 illustrates a process for ammunition pricing and SKI management. In some embodiments, the system searches the internet daily using 80+ different online ammunition retailers and collects the prices on each product SKU in step 600. In step 610, the system collects these and aggregates the prices per our general SKU and creates a high, low, median price and suggestion for pricing ammo. The system identifies prices that are higher or lower than what we have priced an SKU at. In step 620, the system visually shows this in a chart over time to view and identify the price trend.

### Shipping and Physical Delivery

FIG. 7 illustrates a process for shipping and delivery of the ammunition as shown in step 700-720. Eventually the system will recognize that a customer will want physical ammunition. Ammunition allocated in the customer account becomes shippable on demand or automatically (via auto-ship) in full box sizes. It is still in a generic SKU format until they request shipping. Once they request shipping our system has an algorithm that gathers multiple pieces of data on the aggregated SKU's available to select from the current inventory. The data we use is our internally assigned quality levels, cost, box size, price, and inventory quantities to automatically select how many of each specific SKU a customer should get. For example, a customer might have 245 rounds of 9 mm Self Defense. The algorithm will pick 4 boxes of 50 (1) Product SKU A, (2) Product SKU B and (1) Product SKU C brands along with a box of 25 rounds of Product SKU D and lastly another box of 20 rounds of SKU E. The goal of the algorithm is to optimize and convert the customers' generic inventory into specific inventory in the most efficient and fair way as possible.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A system for using ammunition as a medium of exchange between online parties, the system comprising:
at least one user computing device in operable connection with a user network;
an application server in operable communication with the user network, the application server configured to host an application program for using ammunition as a medium of exchange between online parties, the application program having a user interface module for providing access to the application program via the at least one user computing device;
a processor and a non-transitory, computer readable memory storing instructions that, when executed by the processor upon a user selection, cause the device to:
search a plurality of databases for a plurality of ammunition prices;
attribute each of the plurality of ammunition prices to a caliber; and
permit a sender to select an amount of each caliber of ammunition to transfer to a recipient, wherein the transfer is associated with a generic SKU.

2. The system of claim 1, further comprising a pricing module to determine a median price associated with the caliber of ammunition.

3. The system of claim 2, wherein the user establishes a limit price associated with the plurality of ammunition prices, wherein the ammunition is bought or sold using the limit price.

4. The system of claim 1, further comprising an allocation module to establish a specific SKU once an allocation is established.

5. The system of claim 4, wherein the allocation module converts the generic SKU to a specific SKU.

6. The system of claim 1, wherein the amount of each caliber of ammunition is a fractional amount.

7. The system of claim 1, wherein the plurality of ammunition prices corresponds to a dollar amount transferable between the sender and the receiver.

8. The system of claim 1, further comprising a communication module to permit the recipient to request the allocation of ammunition from the sender.

9. The system of claim 1, further comprising a communication module to permit a sender to initiate the allocation of ammunition to the recipient.

10. A system for using ammunition as a medium of exchange between online parties, the system comprising:
at least one user computing device in operable connection with a user network;
an application server in operable communication with the user network, the application server configured to host an application program for using ammunition as a medium of exchange between online parties, the application program having a user interface module for providing access to the application program via the at least one user computing device;
a processor and a non-transitory, computer readable memory storing instructions that, when executed by the processor upon a user selection, cause the device to:
search a plurality of databases for a plurality of ammunition prices;
attribute each of the plurality of ammunition prices to a caliber; and
permit a sender to select an allocation percentage associate with a budget, wherein the allocation percentage is associate with a generic SKU associated with an amount of each caliber of ammunition to transfer to a recipient, wherein an allocation module converts the generic SKU to the specific SKU.

11. The system of claim 10, further comprising a pricing module to determine a median price associated with the caliber of ammunition.

12. The system of claim 11, wherein the user establishes a limit price associated with the plurality of ammunition prices, wherein the ammunition is bought or sold using the limit price.

13. The system of claim 10, further comprising an allocation module to establish a specific SKU once an allocation is established.

14. The system of claim 13, wherein the allocation module converts the generic SKU to a specific SKU.

15. The system of claim 10, wherein the amount of each caliber of ammunition is a fractional amount.

16. The system of claim 10, wherein the plurality of ammunition prices corresponds to a dollar amount transferable between the sender and the receiver.

17. The system of claim 10, further comprising a communication module to permit the recipient to request the allocation of ammunition from the sender.

18. The system of claim 10, further comprising a communication module to permit a sender to initiate the allocation of ammunition to the recipient.

19. The system of claim 10, wherein a customer establishes an auto-ship protocol.
